(19) United States
(12) Patent Application Publication
(10) Pub. No.: US 2011/0169316 A1
(43) Pub. Date: Jul. 14, 2011

(54) Portable Travel Headrest

(76) Inventors: Marques Paul Goei, Beaverton, OR (US); Andrew Gerald Victor Oldknow, Beaverton, OR (US)

(21) Appl. No.: 12/685,668

(22) Filed: Jan. 11, 2010

(51) Int. Cl. B60N 2/48; A47C 7/36

(52) U.S. Cl. 297/391

(57) ABSTRACT

A portable travel headrest for supporting the head of a seated individual includes a head cradle with a cushion (100), a base footing (200), and a medial support (300) vertically sandwiched between the head cradle and the base footing. Semi-rigid materials are used to beneficially reduce bulk. In one embodiment, the use of semi-rigid materials also advantageously allows for adding couplers (401, 402) to compact, adjust, and replace the headrest parts.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### TECHNICAL FIELD

This invention relates to the field of a portable headrest for supporting the head of seated individual. The headrest is particularly, although not exclusively, for supporting the head of an individual while traveling in a vessel such as an airplane, train, bus, or automobile.

### BACKGROUND OF THE INVENTION

The field of a portable headrest is generally known to address an individual's need for support of their head while resting or sleeping in a seated position. If a head is not supported while a seated individual is resting or sleeping, head flop or head sag occurs which interrupts rest or sleep, and can contribute to neck soreness. Many travelers are routinely confined to seats where they must remain for hours at a time, affording an opportunity to rest or nap. Therefore, there is a need to overcome the natural lack of head support while in these seats. But, many times, there are space limitations during travel. In the area of airline travel for example, the airlines are cutting the number and size of items that passengers are allowed to carry on board. So making good use of space is essential. Today's travelers desire headrests that are compact, convenient, portable, and lightweight.

### SUMMARY OF THE INVENTION

The present invention as claimed relates to the concept of providing a support for the head of a seated individual while resting or sleeping. The headrest provides support for the head of a seated individual using a head cradle with a semi-rigid portion, a base footing with a semi-rigid portion, and a medial support with a semi-rigid portion vertically sandwiched between the head cradle and the base footing. The head cradle also has a cushion attached. This efficient configuration maximizes comfort while eliminating unnecessary bulk, allowing for ease of compactness and thus portability and convenience.

One embodiment of the present invention is dedicated to headrest compactness and adjustability using couplers and detachable features. In an additional embodiment, the portable headrest is a single molded plastic semi-rigid structure with cushioning attached.

Other features, advantages, and objects of the embodiments of the present invention will become apparent with reference to the following description and accompanying drawings.

### MODE OF OPERATION

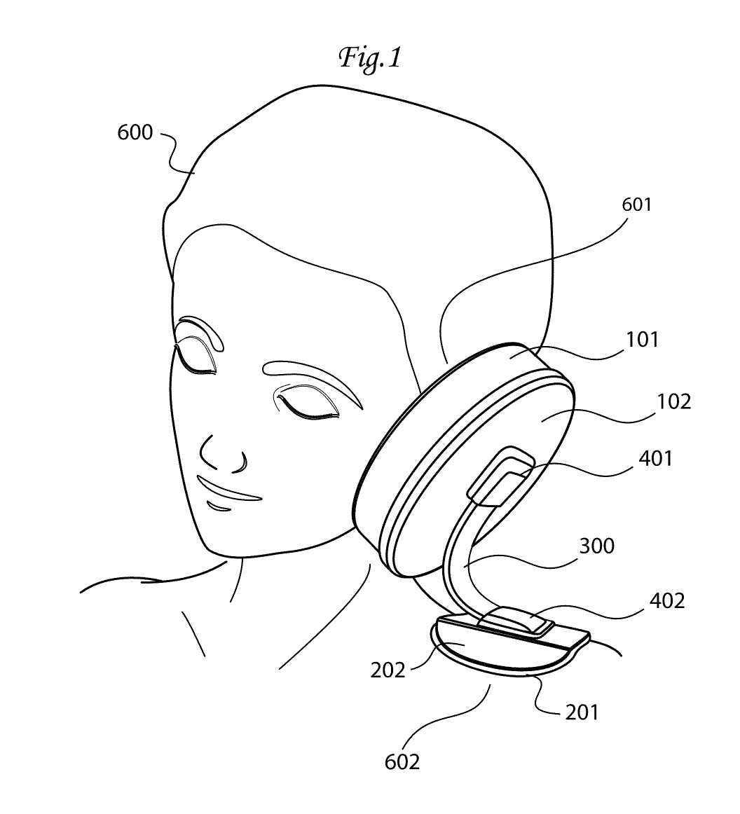

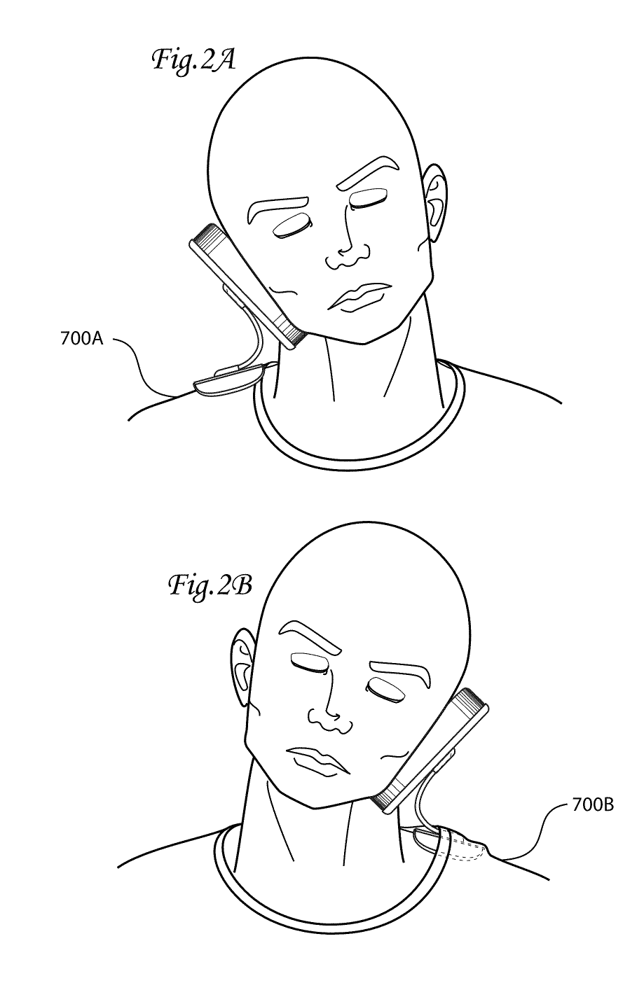

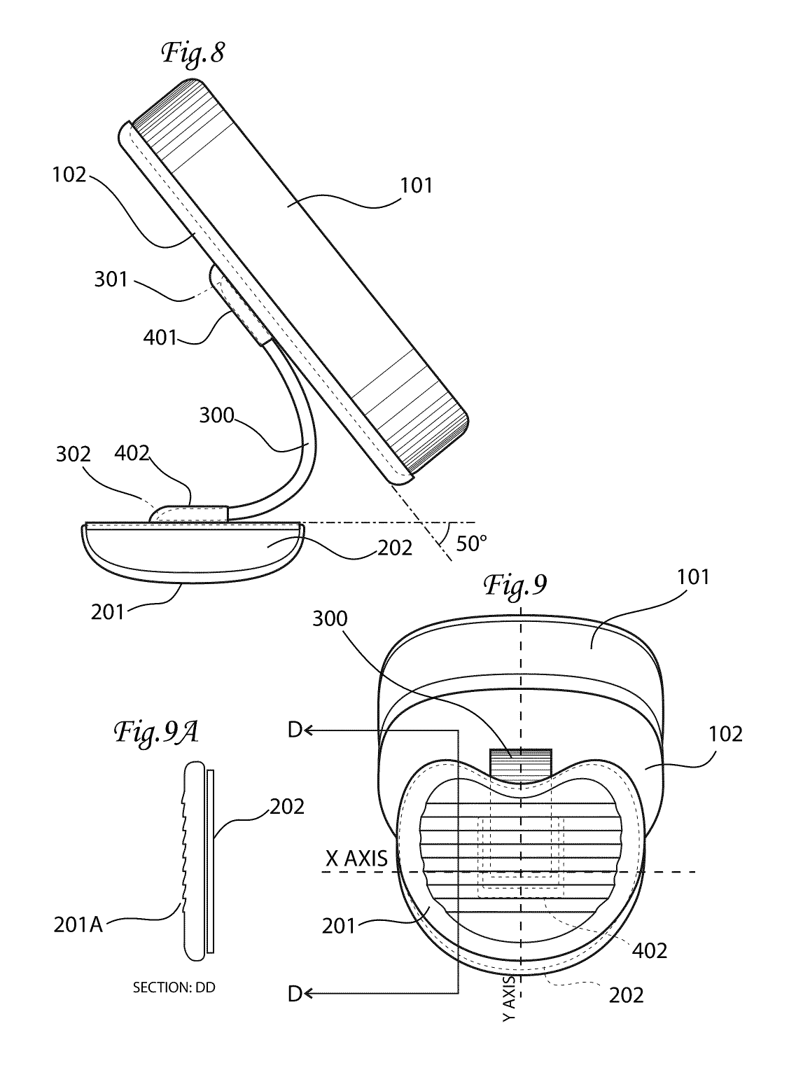

“Head flop” is generally caused by an absence of head support by the neck, as opposed the simple tilting of the head of a resting individual in a seated position. As the neck relaxes, the head and neck both collapse, causing the head to fall in an uncomfortable position. To support the rested head, an effective headrest must compensate for the collapsing neck. The embodiments of the present invention are designed to hold the neck generally upright by providing an elevated head cushion 101 (FIG. 3) near the individual's jaw-line. When in use, the cushion allows the individual's head to tilt from the base of the skull, without the neck collapsing, as the jaw contacts the head cradle 100 (FIG. 3). The present embodiments of the headrest specify the head cradle angle relative to horizontal to be about 45° to 55° (FIG. 8). However, as the user first places the base footing along their shoulder close to the neck and then places their head against head cradle, the head cradle cushion compresses most near the jaw, thereby supporting the tilted head at a more upright angle than the head cradle angle (FIG. 2A). The initial contact and compression of the cushion by the lower part of the mandible followed by the temporal area, causes a slight vertical rotation of the head. This rotation helps pull the headrest toward the user, as opposed to the resting head weight merely pushing it away. This pulling action, along with the downward force of the user's rested head causes the headrest's medial support 300 (FIG. 1) to be pulled slightly inward (toward the user), which causes the base footing 200 (FIG. 3) to press on the user's shoulder more significantly downward than outward, thus allowing the headrest base footing, in combination with its gripping characteristic, to remain stable in support of the user's rested head without the need of straps, cords, clamps, or excess bulk. The present embodiments specify the use of a base footing cushion with a gripping characteristic attached to its first surface. However, the base footing first surface itself could be textured integrated into the semi-rigid portion itself with no attached gripping materials. Stating that the base footing has a semi-rigid portion therefore means that the base footing could be entirely semi-rigid with no cushion, yet having texture for gripping integrated into it, or it could have other gripping materials attached to its first surface. A portion may constitute a part or a whole.

The embodiments of the present invention comprise semi-rigid portions. For this specification, the term semi-rigid means any member that is somewhat or partly rigid but showing reversible deformation properties when moderate force is applied and released, the moderate force being about the weight of a rested human head of about 4.5 kg to about 5 kg on average. The parts or portions can be made more or less rigid by increasing or decreasing the dimensional thicknesses respectively, as well as by fabricating the parts or portions from materials with suitable levels of rigidity to adequately perform their specific functions. For example, the headrest embodiments function similarly whether or not the base footing and head cradle semi-rigid portions were instead made to be greatly rigid. However, the same headrest embodiments' performance will vary significantly if the medial support were to be changed from semi-rigid to greatly rigid due to its vertical thickness, which may or may not flex, depending on the material properties. Therefore, the dimensions of the medial structure are dependant upon the rigidity of the material from which it is constructed.

The headrest semi-rigid portions, namely of the head cradle, medial support and base footing may be of the same material, or a combination of materials such as: the head cradle and medial support being of the same material, the head cradle and base footing being of the same material, and/or the base footing and medial support being of the same material.

The head cradle must be of sufficient size to support the head. Sufficient size of head cradle refers to a size that allows for head cushion top surface being pressure relieving enough to comfortably avoid concentrated pressure points on a human user's resting head, while providing lateral and horizontal support to the head. Depending on the shape and materials used, as well as the placement on the head, the head cradle semi-rigid portion first surface approximate surface area should be in the range of about 25 sq cm to about 256 sq cm.

The base footing must also be of sufficient size to perform properly. Sufficient size of the base footing refers to a size that allows for the base footing lower gripping surface to be pressure relieving enough to comfortably avoid concentrated pressure points on the individual's shoulder area while the headrest is in use. Depending on the size and shape of materials used, as well as the area of contact with the user, the base footing's first surface area should be about 25 sq cm to about 140 sq cm. The base footing should be anywhere from about 0.5 cm to about 3 cm thick and can be different thicknesses within that range in different areas of the base footing. For example, the lower edge thickness of the head cradle could be 3 cm thick to form a raised edge, but the rest of the head cradle could be 0.5 cm thick.

### DETAILED DESCRIPTION

### First Embodiment—FIGS. 3, 4, 7A, 8, 9, 10, 11

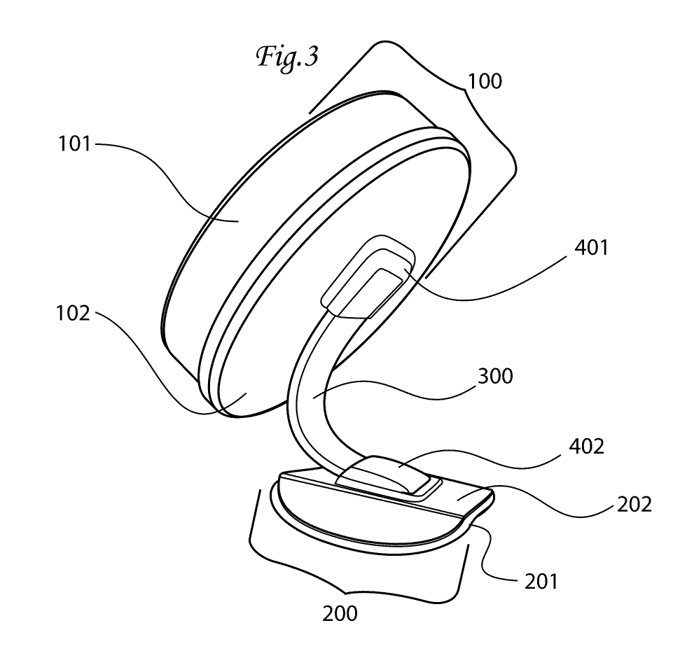

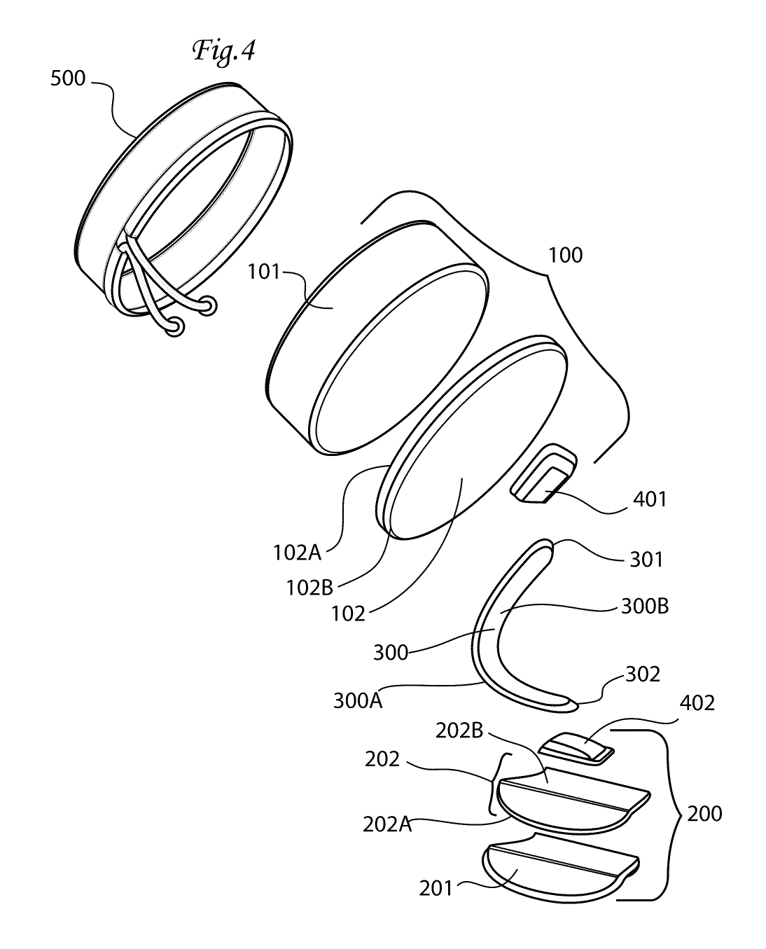

The headrest in this embodiment has a head cradle 100 (FIG. 3) with a semi-rigid portion 102 (FIG. 3) and a head cushion 101 (FIG. 3) attached, a semi-rigid medial support 300 (FIG. 3), and a base footing 200 (FIG. 3) with a semi-rigid portion 202 (FIG. 3.) and a base footing cushion 201 (FIG. 3) attached, female couplers 401, 402 (FIG. 3), and a headrest cover 500 (FIG. 4).

The female couplers 401, 402 (FIG. 4) are attached to the second surface of head cradle 102B (FIG. 4) and base footing 202B (FIG. 4). Medial support ends 301, 302 (FIG. 4) are shaped as male couplers to fit with respective female couplers, and the medial support 300 (FIG. 4) takes the form and function of a “spine” and may be referred to as a “spine” in the following discussion.

In this embodiment, the semi-rigid parts are made of a moldable plastic, such as heat moldable polystyrene plastic. The semi-rigid portion of the head cradle 102 (FIG. 4), is made of a 2 mm thick sheet of polystyrene, fabricated to an approximate oval shape with dimensions 13 cm length×10 cm width×2 mm thick. An upper end and a lower end is designated for reference in construction, as well as the designation of a “first surface” and (opposite side) “second surface”.

A fabricated female coupler with opening dimensions 25 mm length×2 cm width×3 mm thick (depth) 401 (FIG. 4) is adhered to a side (second surface) of head cradle with solvent cement. Female coupler is to be located so that the opening is 6 cm from bottom of head cradle along y-axis and centered along x-axis 401 (FIG. 11) with opening facing downward. Head cushion is fabricated from a 4 cm thick visco-elastic foam as an oval shape to the length and width of the head cradle semi-rigid portion, being 13 cm length×10 cm width×4 cm thick, and adhered onto first surface 102A (FIG. 4) of head cradle.

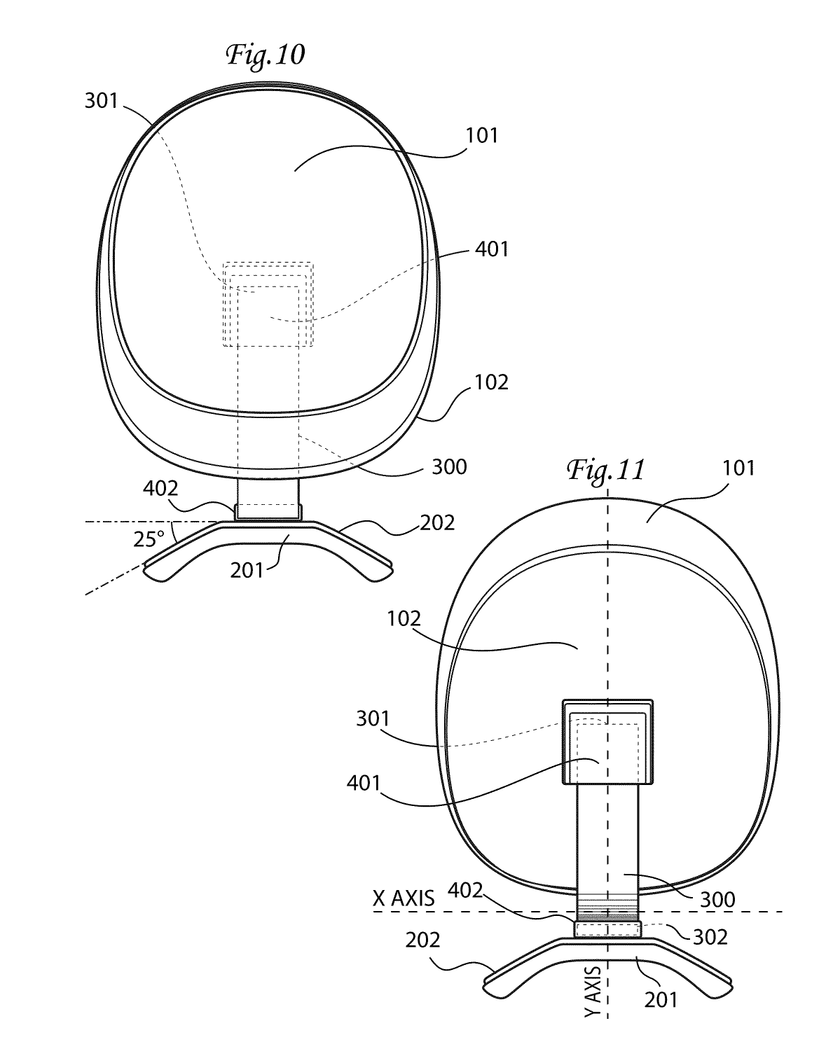

The base footing semi-rigid portion 202 (FIG. 3) is fabricated from a 2 mm thick sheet of polystyrene into an approximate square shape with dimensions 7 cm length×8 cm width×2 mm thick but with corners rounded to a 25 mm radius. An “upper end” and a “lower end” are designated for reference in construction, as well as the designation of a “first surface” and (opposite side) “second surface”. Base footing is given an ergonomic shape (FIG. 7A) with two parallel bends along the y-axis (FIG. 9) toward second surface, bends being 2 cm from base footing edges on both sides, having approximate angle of 25 degrees (FIG. 10) to horizontal. A second female coupler is fabricated with opening dimensions 25 mm length×20 mm width×3 mm thick (depth) 402 (FIG. 4) and adhered to convex side (second surface) of base footing semi-rigid portion 202B (FIG. 4), with solvent cement. Female coupler is located so that the opening is 2 cm from front of base footing semi-rigid portion along y-axis and centered along x-axis 402 (FIG. 9). Medium density foam of 3 cm thickness is adhered onto first surface of base footing 202A (FIG. 4), covering surface completely. Ribbed high friction elastomer 3 mm thick, is adhered onto the entire top surface of the base footing's initial foam layer.

Medial support (spine) is polystyrene with dimensions of 130 mm length×22 mm width×3 mm thick and shaped as in 300 (FIG. 4), curvature approximates a radius of 3 cm, and minimum of 22 mm on each end of spine are left flat. The angle of spine ends in relation to each other are to be approximately 50° (FIG. 8), with spine set flat on a horizontal surface and spine lower end facing downward, the spine upper end will be directly above lower end along the y axis. Spine ends are shaped as tapered male couplers 301, 302 (FIG. 4), which insert simply but strongly into female couplers 401, 402 (FIG. 4). The first embodiment's use of couplers, enable it to be compacted for storage, adjusted for sizing preferences, and detachable for part replacement.

Operation-First Embodiment-FIGS. 2a, 2b, 9a

A way to utilize second embodiment is by placing base footing along top of shoulder with the medial support close to user's neck, and head cushion facing side of user's head. User can lean same side head against head cushion, and due to pressure exerted through the medial support the base footing stabilizes on user's shoulder. The friction properties of the head cushion or its cover, friction properties of the base footing, and minor flexing of the medial support, combine to hold headrest in place. The headrest can be used on either the right 700A (FIG. 2A) or the left 700B (FIG. 2B) side of the user. Additionally, directional ribbing 201A (FIG. 9A) offers increased grip when head rest base footing is pushed away from the neck along user's shoulder when in use, but offers less grip when headrest is pulled toward the user's neck when positioning the headrest for use.

The headrest can be placed either on top 700A (FIG. 2A) of, or underneath 700B (FIG. 2B) the user's clothing for purposes of being hidden. Further benefit of increased stability, if desired, is through user's body position such as having arms crossed in front of body or elbows up on arm rests, thereby raising the shoulder-neck line to be more horizontal.

### DETAILED DESCRIPTION AND OPERATION

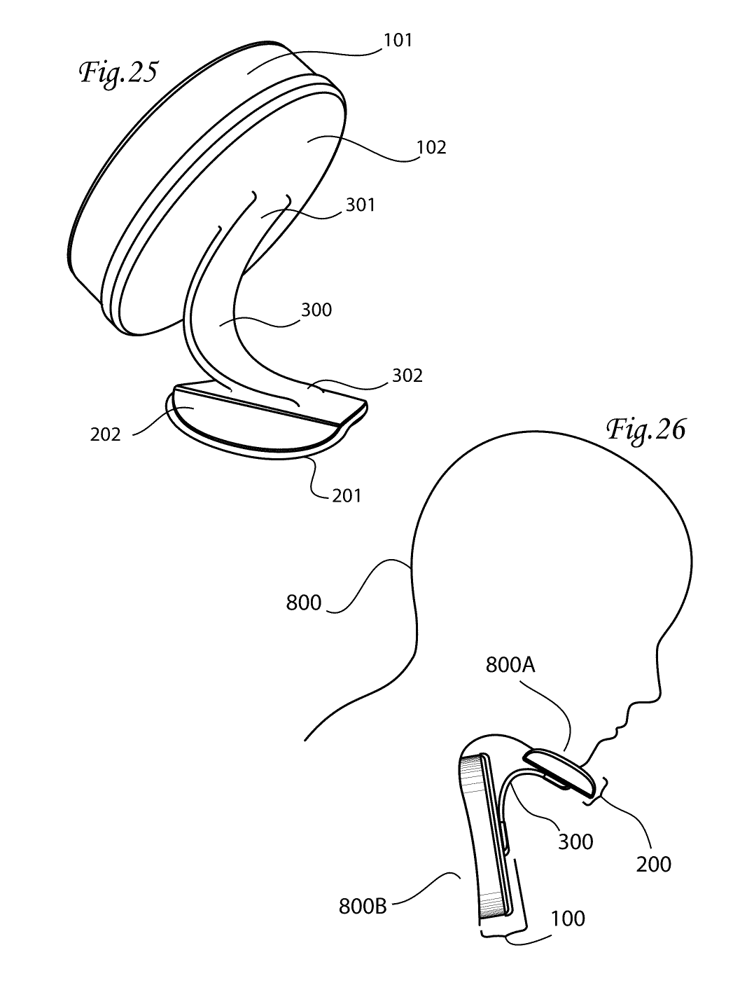

### Second Embodiment—FIG. 25

The headrest in this embodiment has a head cradle with a semi-rigid portion 102 (FIG. 25) and a head cushion 101 (FIG. 25) attached, a semi-rigid medial support 300 (FIG. 25), and a base footing with a semi-rigid portion 202 (FIG. 25.) and a base footing cushion 201 (FIG. 25) attached. The medial support upper end 302 (FIG. 25) is attached to the second surface of the head cradle, and medial support lower end 302 (FIG. 25) is attached to the second surface of the base footing. Dimensions of the headrest's semi-rigid portions, materials of the headrest's semi-rigid portions, and dimensions and locations of cushioning material remain the same as first embodiment, as well as usage. This embodiment has an advantage over the first embodiment, that being a higher throughput during manufacturing because of fewer separate manufactured parts.

### DETAILED DESCRIPTION

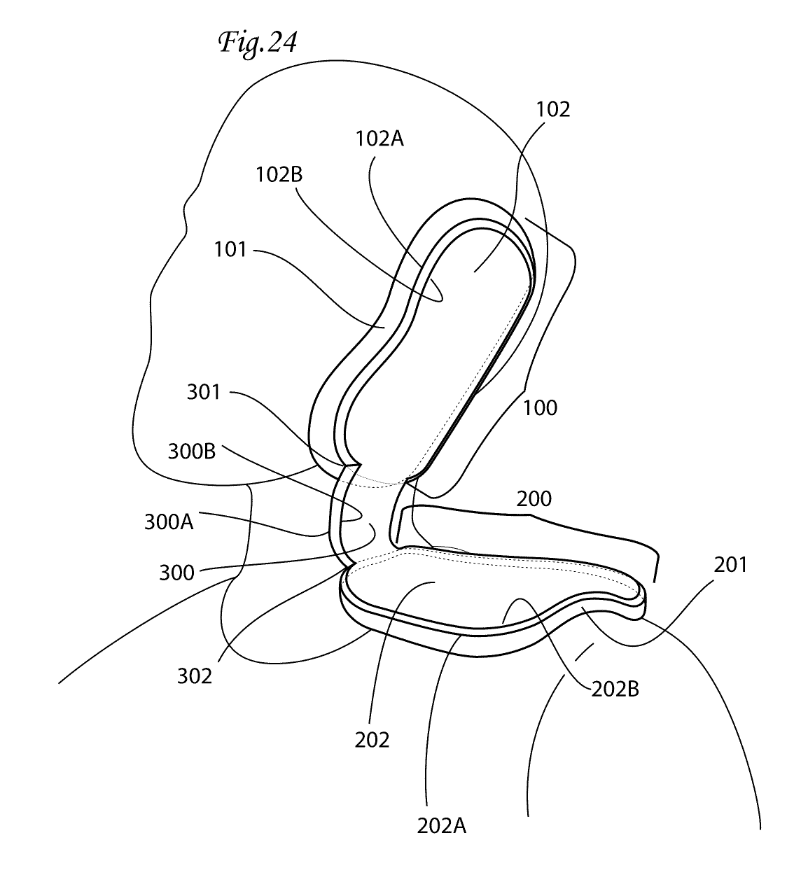

### Third Embodiment—FIG. 24

The headrest in this embodiment has a head cradle, medial support and a base footing, which are formed as a one-piece metal structure 25 cm in length, having a first surface 102A/300A/202A (FIG. 24), a second surface 102B/300B/202B (FIG. 24), and has a visco-elastic cushion 101 (FIG. 24) of 2.5 cm thickness attached to the head cradle's 100 (FIG. 24) first surface 102A (FIG. 24). The head cradle is attached to the medial support at a first point of connection 301 (FIG. 24) and the medial support is attached to the base footing at a second point of connection 302 (FIG. 24). The base footing first surface has a 1.5 cm thick cushioning material with a gripping characteristic attached.

At a point roughly 8 cm from lower end of metal piece, there is an approximate 90° bend in a direction away from first surface 202A (FIG. 24). At a point roughly 12 cm from upper end of metal piece there is an approximate 45° bend away from first surface 102A (FIG. 24). The structure should be semi-rigid but flex slightly when pressure is applied, such as from the weight of a human head, with the medial support flexing to cause the head cradle's upper end to move rotationally about 1° to 10° from normal.

### Operation—Third Embodiment

A way to utilize third embodiment is by placing base footing along top of shoulder above or under clothing, with the medial support close to user's neck and head cushion facing side of user's head. User can lean same side head against head cradle, and due to pressure exerted through the medial support, the base footing stabilizes on user's shoulder. The friction properties of the head cushion, friction properties of the base footing cushion, and minor flexing of the medial support combine to hold headrest in place. The headrest can be used on either the right or the left side of the user. The headrest can be placed either on top of, or underneath the user's clothing for purposes of being hidden. Further benefit of increased stability if desired is through user's body position such as having arms crossed in front of body or elbows up on arm rests, thereby raising the shoulder-neck line to be more horizontal.

### Alternative Operation of Embodiment

The described embodiments may also be used to support the head of an individual by placement of the headrest along the front side of user (FIG. 26). In this use, the first surface of the base footing 200 (FIG. 26) is in contact with the user's chin 800A (FIG. 26), and the first surface of the head cradle 100 (FIG. 26) is pressed against the user's chest 800B (FIG. 26), either on top of, or underneath the user's clothing for purposes of being hidden. This method of placing the inverted headrest along the front side of the user may be preferred by individuals wanting to rest their heads in a forward leaning position as opposed to a side tilted position.

### Alternative Embodiments

I presently contemplate that the described first, second and third embodiments' semi-rigid portions can be made of many other materials besides polystyrene plastic or metal; however, plastics have many benefits over such materials as woods and metals due to their ease of fabrication, strength to weight ratio, ability to manufacture different colors, and cost considerations. The portions may also be made of differing materials than each other; for example, the head cradle and base footing could be made of metal, and the medial support could be plastic. In addition, many types of cushioning materials and more than one layer of cushion densities can make up a single cushion on the head cradle and/or the base footing, including open and closed cell foams, gels, elastomers, and sponge.

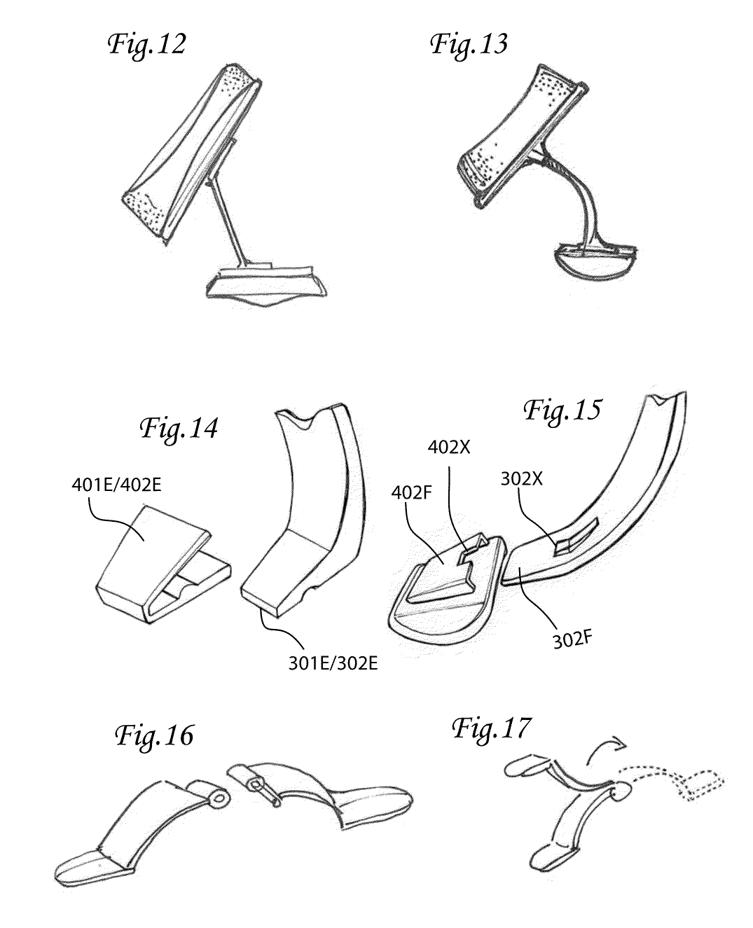

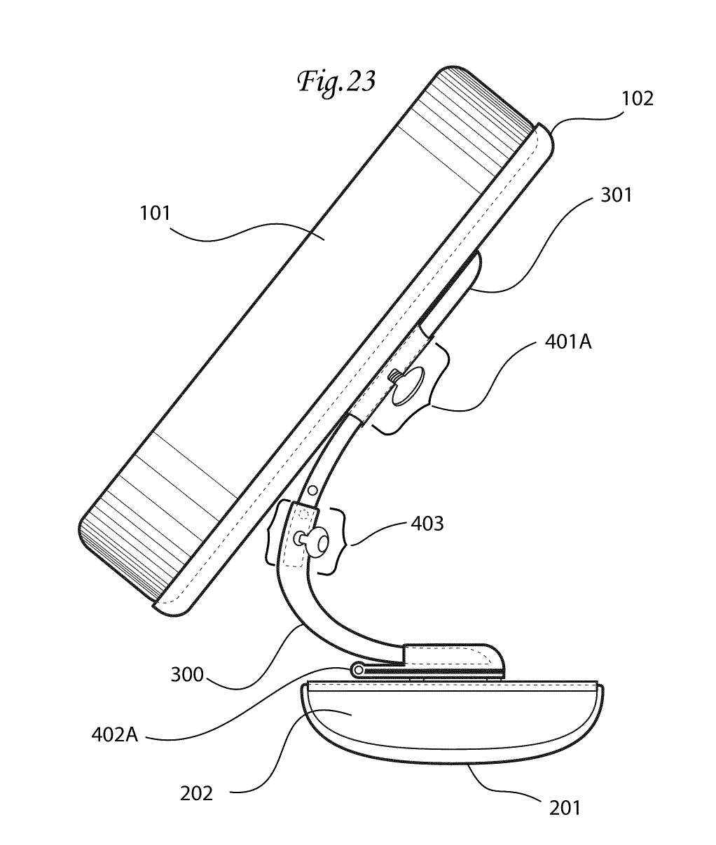

Some alternative coupling and compacting means, as well as alternative medial supports, are shown in (FIG. 12 thru FIG. 21). Different coupler types can be used on the same headrest. For example, FIG. 20 and FIG. 21 show female couplers having dual openings to adjust for height and/or angle of male coupler insertion. Male/female couplers also can have indicator properties to for designating proper assembly of respective parts, such as a notched female coupler and male coupler with corresponding indicator tab (FIG. 15). Some couplers also will have a locking feature such as a grooved snap-lock (FIG. 14) to prevent the accidental dislodging of coupled parts, a screw lock 401A (FIG. 23), or a slide lock 403 (FIG. 23), which will selectively lock the coupled parts into place. Some of the couplers will allow the headrest to detach when desired for collapsing the headrest while not in use, and others will keep the coupled parts permanently attached yet collapsible 402A (FIG. 23). Couplers can be of different types rather than tapered male/female ends, such as hinged or ball and socket types; however, tapered male/female ends have advantages of simplicity in fabricating, ease of detachment for compactness, and ease of use. A further benefit of detachment for compactness versus collapsing via hinged couplers is that a fully detachable medial support can easily be replaced with a medial support of different length and/or stiffness to allow user the benefit of customization of the headrest for their individual preference.

The headrest's medial support may further comprise a mechanism that has a reversible deformation property, such as a spring, rubber sphere, and/or flexible rod, which allows the medial support to flex from pressure exerted onto head cradle by the individual's rested head, yet return to its original state when the individual discontinues use.

The medial support may also include different shapes beyond the described embodiment, such as a more linear shape (FIG. 12), opposite curve direction (FIG. 13), multiple member type (FIG. 19), or other shape. The crescent shaped medial support 300 (FIG. 3) has advantages in that the design is simple to construct and follows the general outline of user's same side head/neck/shoulder, causing the headrest to be discreet while in use (FIG. 2B). The distance between medial support upper end and the medial support lower end should be at a linear maximum of 18 cm from the upper end to the lower end regardless of any mechanism that may placed in the medial support.

The head cradle and the base footing can be made into different sizes and shapes, such as oblong, ergonomic, and/or decorative (as in a flower, heart, etc), as long as it is of sufficient size. In addition, the head cradle in particular has allowance for additional features such as an indent placed in the center of the head cushion, a hole placed in the center of the cushion, and even a hole further continuing through the attached semi-rigid portion to form a head cradle shaped like a donut. This elimination of materials in the approximate center of the head cradle in a location corresponding with a user's ear would allow for use of earphones, noise canceling headphones and other travel comfort technologies.

### CONCLUSION, RAMIFICATIONS, SCOPE

Thus, the reader can see that using cushioning for the main purpose of comfort and grip and only where contact with the user is necessary, and using semi-rigid materials for the purpose of support and elevation in the embodiments of the present invention makes for an efficient way to maximize comfort and support while minimizing bulk, weight and volume. The above described embodiments are intended to illustrate the principles of the invention, but not to limit its scope. Other variations are possible. The headrest design allows for numerous modifications that enable the present embodiments to be adjustable for size, and collapsible for sake of reducing its volume for storage. Also, the head cradle and/or the base footing could be made of a plurality of semi-rigid stems with small face cushions. Or, a variation of the medial support could be where the medial support has more than one member attached to the head cradle or the base footing. Using the statements ‘comprising “a”’ or ‘made of “a”’ should be considered to mean comprising “at least one” or made of “at least one” and therefore any infringing apparatus that includes more than one still reads on the “a” element. Also, “a portion” means “at least a portion”, and may constitute a whole. Accordingly, the scope should be determined not by the embodiments illustrated, but by the appended claims and their legal equivalents.

### REFERENCE NUMERALS IN DRAWINGS

(100) Head Cradle
(101) Head Cushion
(101A) Head Cushion Foam Layers
(102) Head Cradle Semi-Rigid Portion
(102A) Head Cradle Semi-Rigid Portion First Surface
(102B) Head Cradle Semi-Rigid Portion Second Surface
(200) Base Footing
(201) Base Footing Cushion
(201A) Base Footing Elastomer with Directional Ribbing
(202) Base Footing Semi-Rigid Portion
(202A) Base Footing Semi-Rigid Portion First Surface
(202B) Base Footing Semi-Rigid Portion Second Surface
(300) Medial support
(300A) Medial Support First Surface
(300B) Medial Support Second Surface
(301) Medial Support Upper End, also known as First Point of Connection
(302) Medial support Lower End, also known as Second Point of Connection
(301E/302E) Male grooved snap lock coupler
(302F) Male end of tab/notch indicator coupler

(302X) Protruding indicator tab
(401) Head Cradle Coupler
(401A) Screw Lock Coupler
(401E/402E) Female grooved snap lock coupler
(402) Base Footing Coupler
(402A) Hinged Coupler
(402F) Female end of tab/notch indicator coupler
(402X) Recessed indicator notch
(403) Slide Lock Coupler
(500) Head Cushion Removable Cover
(600) Headrest User
(601) Headrest User's Side of Head
(602) Headrest User's Shoulder
(700A) Headrest Being Used on User's Right Shoulder Above Clothing
(700B) Headrest Being Used on User's Left Shoulder Under Clothing
(800) Individual resting head forward with inverted headrest utilized along front side of body (alternative usage)
(800A) Individual's chin resting on base footing
(800B) Individual's chest supporting head cradle

### SEQUENCE LISTING OR PROGRAM

Not Applicable

### BRIEF DESCRIPTION OF THE DRAWINGS

FIG. 1 is front ¾ view illustration of an individual's upper body using a portable travel headrest constructed in accordance with the teachings of the present invention.

FIG. 2A is front view of an individual's upper body using the portable travel headrest on his right side.

FIG. 2B is front view of an individual's upper body using the portable travel headrest on his left side, with the base footing underneath individual's clothing.

FIG. 3 is a rear ¾ view illustration of the headrest.

FIG. 4 is an exploded view of the portable travel headrest illustrating an unassembled sequence of parts.

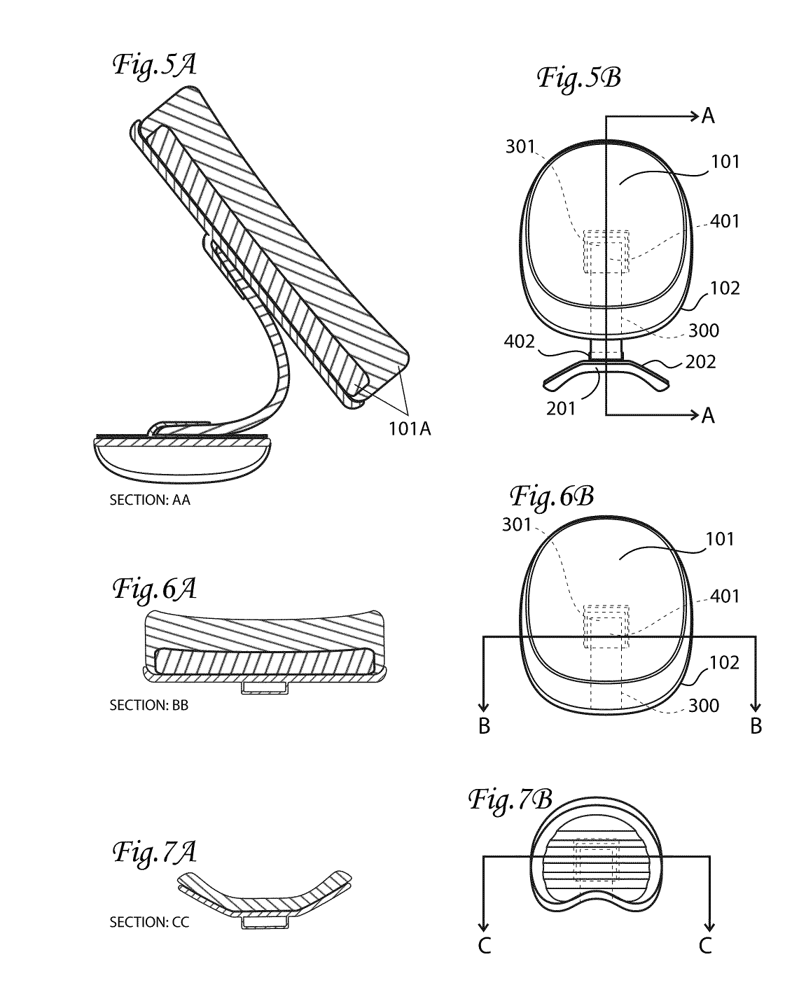

FIG. 5A is a side cross sectional view of the portable travel headrest section AA.

FIG. 5B is a reference illustration explaining the section AA view.

FIG. 6A is a bottom end cross sectional view of head cradle section BB.

FIG. 6B is a reference illustration explaining the section BB view.

FIG. 7A is a front end cross sectional view of base footing section CC.

FIG. 7B is a reference illustration explaining the section CC view.

FIG. 8 is a right side elevation view of the headrest.

FIG. 9 is a bottom-up view of the headrest.

FIG. 9A is a cross sectional view of base footing elastomer with unidirectional ribbing section DD.

FIG. 10 is a front side elevation view of the headrest.

FIG. 11 is a rear side elevation view of the headrest.

FIG. 12 is an elevation view of a headrest comprising a straight medial support.

FIG. 13 is an elevation view of a headrest comprising a medial support showing a convex curvature.

FIG. 14 shows a front ¾ view of a male and female coupler of a grooved snap lock variety.

FIG. 15 depicts a notched female coupler and male coupler with corresponding indicator tab, for designating proper assembly of respective parts.

FIG. 16 shows a medial support with a fully detachable medial coupler.

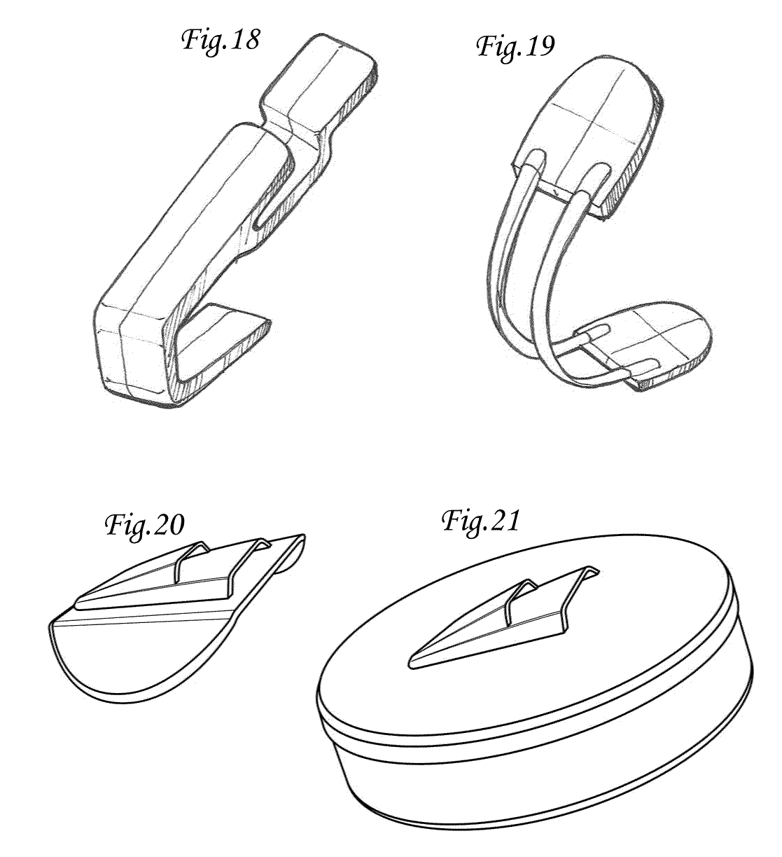

FIG. 17 shows a medial support with a hinge, allowing for compactness.

FIG. 18 shows a medial support with dual male couplers at the top end, allowing for adjustable height of the head cradle.

FIG. 19 shows a medial support with dual members connected to upper and lower male couplers.

FIG. 20 shows a base footing with an attached female coupler having dual openings, allowing for varied height and/or angle of male coupler insertion.

FIG. 21 shows a head cradle with an attached female coupler having dual openings, allowing for varied height and/or angle of male coupler insertion.

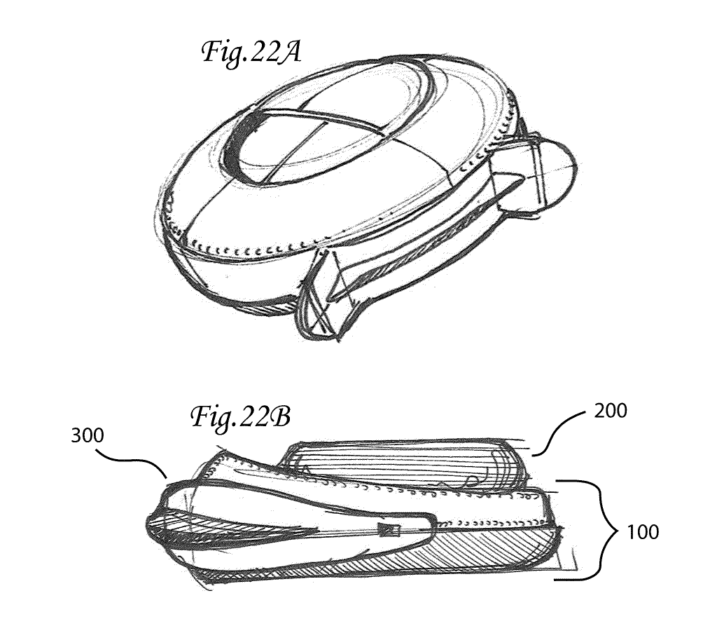

FIG. 22A is a ¾ view illustration of a detached and compacted headrest.

FIG. 22B is a side elevation view illustration of a detached and compacted headrest. This view shows the head cradle, cushion side up, with the base footing set on the head cushion and the medial support wrapped around the perimeter of the head cradle.

FIG. 23 enlarged view shows a headrest comprising a hinged coupler at the base footing, an adjustable slider coupler in the medial support, and a screw lock coupler at the head cradle.

FIG. 24 shows a basic one-piece headrest, as described in embodiment 3, in use with references to the respective parts.

FIG. 25 shows a headrest depicting a one-piece molded type where the medial support connects to the head cradle and base footing at their approximate midpoints.

FIG. 26 shows a side view of an individual's upper body while alternatively using the headrest along the front side of the body, with the head forward and the chin set upon the base footing and the head cradle pressing upon the chest for stability.

I claim:

1. A portable headrest for supporting the head of a seated individual, said portable headrest comprising:
a) a head cradle with a semi-rigid portion having a first surface and a second surface, and a cushion attached to said semi-rigid portion's first surface;
b) a base footing with a semi-rigid portion having a first surface and a second surface, and a gripping characteristic on said semi-rigid portion's first surface.
c) a medial support having an upper end and a lower end; and
d) said head cradle connected to the medial support's upper end at a first point of connection, and said base footing connected to the medial support's lower end at a second point of connection, so that the configuration forms a headrest where the medial support is sandwiched between said head cradle and said base footing, and the head cradle is raised and supported by the medial support at distance above said base footing and on a generally vertical plane above said base footing while in use,
whereby said semi-rigid portions eliminates the need for bulk adjacent to said seated individual's neck area.

2. The headrest according to claim 1 wherein said medial support upper end and said medial support lower end have a linear distance between the two ends, the maximum linear distance being less than 18 cm from said upper end to said lower end.

3. The headrest according to claim 1 wherein said medial support is semi-rigid.

4. The headrest according to claim 3 wherein said medial support is of sufficient strength to withstand a downward force exerted by the seated individual's head resting on the head cradle, while said headrest is in use.

5. The headrest according to claim 4 wherein said medial support is an elongated, vertical, generally crescent-shaped curvature which renders the medial support to be close enough to an individual's neck so that said medial support can be placed between the individual's neck and collar while in use.

6. The headrest according to claim 5 wherein said medial support has a reversible deformation property so that said medial support deforms under pressure exerted from a resting head, and returns to normal when said pressure is lifted.

7. The headrest according to claim 1 wherein said medial support upper end is connected to said head cradle semi-rigid portion's second surface.

8. The headrest according to claim 1 wherein said medial support lower end is connected to said base footing semi-rigid portion's second surface.

9. The headrest according to claim 1 further comprising a coupler at a location consisting essentially of (i) at said first point of connection (ii) at said second point of connection (iii) within medial support.

10. The headrest according to claim 9 wherein said coupler renders the respective coupled parts to have a feature selected from group consisting essentially of (i) being permanently attached yet collapsible (ii) being adjustable (iii) being detachable.

11. The headrest according to claim 9 wherein said coupler further comprising a locking means to prevent the respective coupled parts from moving when said coupled parts are placed in a desired position.

12. The headrest according to claim 9 wherein said coupler is of a male/female type.

13. The headrest according to claim 12 wherein said male/female coupler further comprising identifying marks to indicate proper placement.

14. The headrest according to claim 12 wherein said male/female coupler further comprising a grooved snap-lock.

15. The headrest according to claim 1 wherein said head cradle semi-rigid portion and said medial support are contiguous and formed as single, undivided piece.

16. The headrest according to claim 1 wherein said base footing semi-rigid portion and said medial support are contiguous and formed as a single, undivided piece.

17. The headrest according to claim 1 wherein said head cradle semi-rigid portion, said base footing semi-rigid portion, and said medial support are formed as a single, undivided piece.

18. The headrest according to claim 1 wherein said head cradle further comprising a flexible material cover placed over at least a portion of said head cradle cushion.

19. The headrest according to claim 18 wherein said cover is removable and replaceable.
